(19) United States
(12) Patent Application Publication
(10) Pub. No.: US 2026/0364755 A1
(43) Pub. Date: Nov. 19, 2026

(54) DRILLING AND/OR SCREWING TOOL

(71) Applicant: Heinz OELPMANN, Gronau-Epe (DE)

(72) Inventor: Heinz OELPMANN, Gronau-Epe (DE)

(21) Appl. No.: 19/557,464

(22) Filed: Mar. 5, 2026

Related U.S. Application Data
(63) Continuation of application No. PCT/EP2023/000066, filed on Dec. 21, 2023.

(30) Foreign Application Priority Data
Sep. 5, 2023 (DE) 102023003613.7

(51) Int. Cl. B25B 23/00; B25B 13/06; B25B 23/12

(52) U.S. Cl. CPC B25B 23/0035; B25B 13/06; B25B 23/12

(57) ABSTRACT

A drilling and/or screwing tool, including an axially extending shaft, including an inner axial receiving channel, including a respective rotation secured insertion device configured to receive a torque transferring unit at two axially opposite ends of the inner axial receiving channel, wherein the respective rotation secured insertion device includes retaining devices protruding radially inward and pressable radially inward from a radial outside by a spring force and/or by an outer pressure element imparting a radially inward oriented force upon the retaining devices, so that the torque transferring unit is secured in an axial position.

### RELATED APPLICATIONS

This application is a continuation of international patent application PCT/EP2023/000066 filed on Dec. 21, 2023 claiming priority from German patent application DE 10 2023 003 613.7 filed on Sep. 5, 2023, both of which are incorporated in their entirety by this reference.

### FIELD OF THE INVENTION

The present invention relates to a drilling and/or screwing tool for manual operation, and/or for use in a power tool.

### BACKGROUND OF THE INVENTION

EP 0 968 793 A2 discloses a tool including a shaft, configured to receive a tool for rotating operation at one end of the shaft. A bit holder is insertable at another axial end, wherein the bit holder supports an operating bit. The tool, however, is rather large, in particular it has a substantial axial length. This causes operating limitations, in particular in tight corners od pieces of furniture or of similar small structures which limits applications of the tool.

### BRIEF SUMMARY OF THE INVENTION

The invention aims to solve this problem and provide an improved drilling and/or screwing tool.

The object is achieved by a tool with the features of the independent claims. Advantageous embodiments of the invention can be derived from the dependent claims.

The drilling and/or screwing tool includes an axially extending shaft and an inner axial receiving channel including an insertion device secured against rotation for a torque transferring unit at two axially opposed ends, at least one insertion device configured to axially secure a torque transferring device in position by radially inward protruding retaining devices that are pressable inward by a spring force from a radial outside and/or by a pressure element imparting a radially inward force from an radial outside so that the torque transferring unit is insertable at least at one axial end to engage the retaining devices so that the shaft can be kept very short which facilitates using the drilling and/or screwing tool in tight corners. The retaining devices are provided, in particular, at both axial ends of the shaft in order to reach an input at one side and an output at another side.

Thus, the retaining devices can be arranged in an optimum manner in two axially closely adjacent units in an axial center portion. Thus, both axial ends are useable in the same way for securing torque transferring units. Both inserted torque transferring units are thus insertable into the axial center portion.

Thus, the shaft can be kept particularly short in order to provide minimum dimensions for the tool.

Advantageously, the retaining devices are configured as balls, so that they can counteract forces from all sides in the same manner. A distribution of the retaining devices over a circumference of the shaft can be equidistant.

Preloaded spring jackets are advantageously provided on an outside of the shaft in axial sequence, configured to radially impress the balls and configured to radially preload the retaining devices inward by a spring force, wherein the preloaded spring jackets can be open respectively at one circumferential location. The preloaded spring jackets can be advantageously made from stainless steel and envelop the shaft substantially completely.

When outer circumferential grooves are provided at an outside of the shaft in order to axially secure the pre-loaded spring jackets, wherein an axial length of the grooves respectively corresponds to an axial extension of a spring jacket, the spring jackets can be secured at this location against axial displacement. A rotation safety of the pre-loaded spring jackets is not required.

When the outer pressure element that loads the retaining devices with a radially inward oriented force is formed by an axially moveable sliding sleeve which is secured against axial extraction by at least one snap locking ring (28), a large radial force can be imparted by the outer pressure element. By the same token, a small axial displacement of the sliding sleeve can suffice to bring the retaining devices into a position behind inner relief cuts of the sliding sleeve, so that the retaining devices are released far enough so that an otherwise retained torque transferring unit can be extracted easily.

Advantageously, the pressure element is supportable by a spring-loaded safety in an axial position where the pressure element presses the retaining devices radially inward, indirectly or directly, so that unintentional release of the pressure element is precluded.

Advantageously, at least three retaining devices are distributed over a circumference that are offset relative to each other by 120 degrees and configured to retain a torque transferring unit. In order to secure a support of engaged torque transferring units, the engaged torque transferring units can include a circumferential outer groove or a similar recess closely adjacent to to an axial end of the torque transferring unit, wherein the retaining devices can flex radially inward into the outer groove or recess in order to secure against unintentional axial extraction.

When the rotation secured insertion device forms a hexagon socket, at least in a respective outer end portion, each torque transferring unit inserted into the shaft can form an Allen key in order to provide reliable torque transfer without slippage. Other retaining profiles are certainly feasible as well, for example, a twelve-or eighteen-point profile or a torx-or star shape.

In particular, one Allen socket has an inner dimension of 10 mm and an additional Allen socket has an interior dimension of 13 mm. Other dimensions, e.g. standard dimensions in inches are also feasible. Thus, flipping the shaft can provide an adaptation to various additional tool holders or drive shafts. Flipping the shaft and reversing the input side and output side greatly increases the field of applications of the shaft.

When the shaft includes an effective stop for an engaging torque transferring unit in a center portion of the receiving channel, wherein the stop is effective from both axial sides, units can be inserted from both sides and advanced to the stop. This helps to minimize the length of the shaft. In particular, the torque transferring unit can be inserted on the input side, thus a drive shaft, so that the drive shaft is inserted approximately up to an axial center of the shaft which facilitates a particularly short shaft.

In particular, the drive shaft can be cut out in a radially inner portion to form a receiving cavity. Thus, also, the first torque transferring unit can receive a bit of the second torque transferring unit in a radially inner portion without having to increase the length of the shaft. When the second torque transferring unit, e.g. a bit holder, is configured with two bits on the output side, the second unit is insertable into the shaft in any orientation.

Thus, the drilling and/or screwing tool is connectible through a first torque transferring unit at one axial shaft end with a motor shaft of a drive, or with a handle that forms the drive in order to reach tight corners.

In order to prevent a sudden excessive torque of the driving first torque transferring unit which could sheer off a screw head, the first torque transferring unit can include an elastically deformable torsion element which establishes torque transferring contact when inserted into the shaft. The torsion element can be optimized with respect to elasticity and sliding properties.

In order for a worn torsion element to be replaceable easily, the worn torsion element can be slidable onto the first torque transferring unit and then becomes easily replaceable.

An advantageous embodiment includes a drilling and/or screwing tool, including an axially extending shaft, including an axially inner receiving channel, including a respective rotation secured insertion device for a torque transferring unit at two axially opposed ends, wherein a head piece is applicable to at least one of the torque transferring units, wherein the head piece is provided with a magnetic force that is oriented outward from the drilling and/or screwing tool, so that the head piece is configured to support a screw or a similar operating device by magnetically supporting the screw or the operating device. This head piece is optional. Thus, a minimum tool length without the head piece can be maintained.

Particularly advantageously, the head piece can be applicable to the torque transferring unit in two positions that are flipped relative to each other by 180 degrees. Thus, the head piece can be repulsed from the drilling and/or screwing tool in the second position, so that the head piece forms an axially-outer distal forward end and contacts a received screw or similar operating device before the screw or operating device contacts an inserted bit. Vice versa, the head piece can be pulled directly to the shaft in the first inserted position, so that a bit inserted into a front end remains visible, which facilitates orientation during screw tightening.

The head piece may be axially displaceable in a mounted position by several millimeters relative to a torque transferring unit that supports the head piece in order to be able to disengage the screw from the magnetic end again in a simple manner.

The head piece is axially secured in particular but rotatable relative to the torque transferring unit that supports the head piece, so that the head piece can stop rotating when impacting a base material, so that a work piece surface is not damaged by the head piece.

### BRIEF DESCRIPTION OF THE DRAWINGS

The invention is now described based on advantageous embodiments with reference to drawing figures wherein:

FIG. 1 shows an exploded schematic view of components of the drilling and/or screwing tool according to the invention in a first embodiment without a magnetic head piece and without an outer pressure element;

FIG. 2 shows a view similar to FIG. 1, showing an assembled condition of components of the shaft and additional screw bits and an exemplary screw;

FIG. 3 shows the parts according to FIG. 2 in an inserted condition of the torque transferring units and an additional retained magnet head in a position pulled towards the shaft by a maximum amount;

FIG. 4 shows an illustration similar to FIG. 3, however, showing the magnetic head piece pushed away from the shaft by a maximum amount;

FIG. 5 shows a perspective view of the shaft and the torque transferring units inserted therein on the input side (bottom) and on the torque transferring output side (top);

FIG. 6 shows a perspective view of the unit transferring the torque on the drive side;

FIG. 7 shows the unit according to FIG. 6 in a cross-sectional view.

FIG. 8 shows a perspective view of the shaft;

FIG. 9 shows the shaft according to FIG. 8 in a cross-sectional view.

FIG. 10 shows a perspective view of the torque transferring unit on the output side.

FIG. 11 shows the unit according to FIG. 10 in a cross-sectional view;

FIG. 12 shows the magnetic head piece in a side view;

FIG. 13 shows the magnetic head piece in a perspective view;

FIG. 14 shows the magnetic head piece in a cross-sectional view;

FIG. 15 shows an alternate version of the shaft including an outer pressure element, configured as a sliding sleeve, wherein the pressure element is retained in an inserted position, imparting a retaining radially inward oriented force upon the retaining devices by a radially outward spring loaded safety, which has to be manually impressed in order to axially displace the sliding sleeve;

FIG. 16 shows an exploded view of an advantageous embodiment of the torque transferring unit which includes a replaceable torsion element, insertable into a hexagonal socket of the shaft, wherein the torsion element is securable by a safety ring on the torque transferring unit; and

FIG. 17 shows the torque transferring unit secured by the torsion element in a cross-sectional view and in a perspective view.

### DETAILED DESCRIPTION OF THE INVENTION

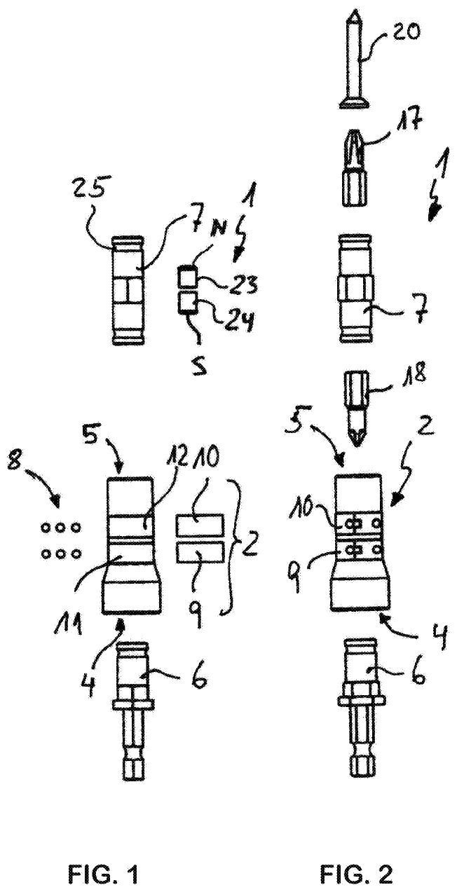

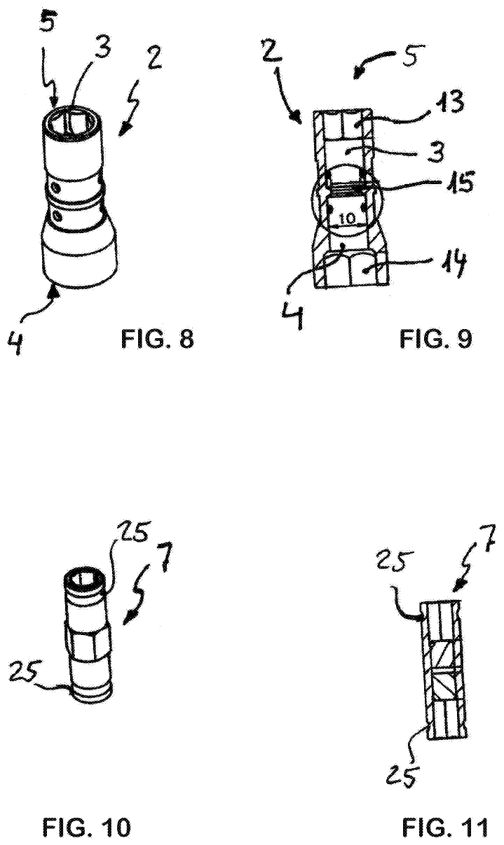

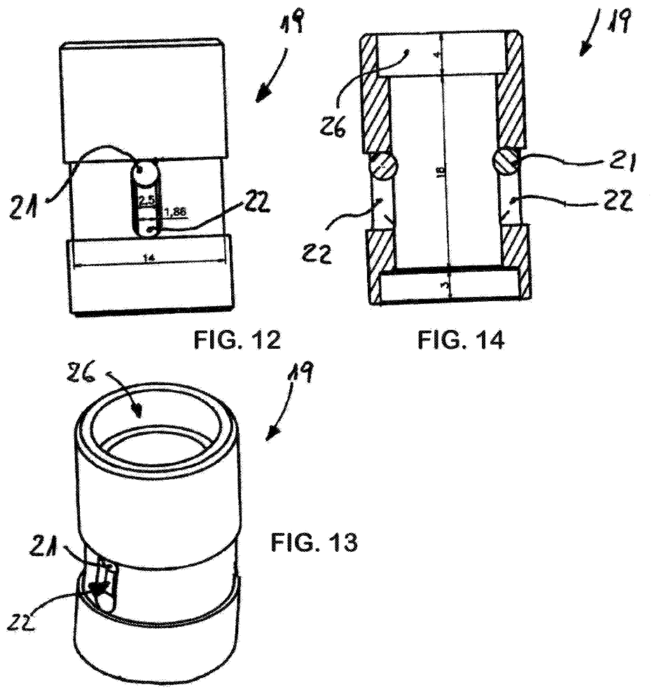

The drilling and/or screwing tool 1, illustrated in a first embodiment in FIG. 1, includes an axially extending shaft 2, including an axial inner receiving channel 3, illustrated e.g. in FIGS. 8 and 9. The shaft 2 respectively forms a rotation secured insertion device for a torque transferring unit 6 or 7 at two axially opposed ends 4, 5. The tool 1 can be driven by hand, e.g. by an axial handle or a ratchet, or by a motor drive, e.g. a cordless drill.

At least one of the insertion devices, or both, recited supra includes an axial position safety for a torque transferring unit 6 or 7. According to this embodiment, both insertion devices arranged opposed to each other by 180 degrees include retaining devices 8 protruding radially inward and configured to be pressed radially inward by a spring force from a radial outside. These retaining devices can engage inserted torque transferring units and provide axial position safety for the torque transferring units.

As evident from FIG. 1, the retaining devices 8 can be configured as balls made, e.g. from stainless steel. The at least three retaining devices are spaced equidistance over a circumference, thus spaced by an angle of 120 degrees between two retaining devices 8 as illustrated in FIG. 8 or FIG. 9. More or fewer retaining devices can also be provided.

Pre-loaded spring jackets 9, 10 are provided to impart the radially inward oriented spring force upon the retaining devices 8, wherein the pre-loaded spring jackets 9, 10 are arranged on an outside of the shaft 2 in axial sequence and preloaded in order to press the balls radially inward. The pre-loaded spring jackets 9, 10 can be arranged at a short axial distance in the mounted position according to FIG. 2 and can be placed about the shaft in an axial center portion of the shaft. The pre-loaded spring jackets 9, 10, thus do not form completely closed rings.

Circumferential grooves 11, 12 are provided to axially secure the pre-loaded spring jackets 9, 10 at an outside of the shaft 2, wherein an axial length of the circumferential grooves respectively corresponds to an axial extension of a spring jacket 9, 10, so that the pre-loaded spring jackets 9, 10 are securely retained against axial displacement. A depth of the grooves 11, 12 thus approximately corresponds to a thickness of the pre-loaded spring jackets 9, 10, so that the pre-loaded spring jackets 9, 10 are arranged flush in the outer wall of the shaft 2 as illustrated in FIG. 2.

The rotation secured insertion device according to FIG. 9, forms a hexagonal socket 13, 14, at least in its outer edge portions 4, 5. These internal hexagonal sockets can be configured differently. A M10 sized socket is provided at one end, and the opposite end 4 includes an M13 sized socket. These sizes are exemplary but used quite frequently in applications. Standard dimensions in inches can certainly be used as well. An input side unit 6 and an output side unit 7, e.g. a bit holder, can engage either side.

In order to securely support inserted torque transferring units 6, 7, the shaft 2 includes a stop 15 for engaging torque transferring units 6, 7 in an axial center portion of the receiving channel 3, wherein the stop 15 is effective from both axial sides. The torque transferring units 6, 7 are thus insertable up to the stop 15 and thus insertable very far until they almost touch axially, so that the torque transferring units 6, 7 are only separated from each other by the narrow stop 15. The shaft 2 can thus be kept extremely short axially, so that maximum operational flexibility is provided.

The shaft can also be used without a bit holder 7, thus, in order to thread a nut in or out. Thus, a threaded bolt that supports the nut can penetrate deeply into the receiving channel 3. Thus, the tool 1 cannot only engage a head side of a bolt 20, but can engage a nut side as well. Thus, threaded bolts of M6 or M8 bolts can penetrate the receiving channel 3, depending on orientation. Thus, operational flexibility of the drilling and/or screwing tool 1 is significantly increased, since opening or closing of nuts and bolts can be easily performed by receiving the threaded bolt in the shaft 2 of the tool 1; however, the shaft 2, however, can still be kept very short.

As described supra, the drilling and/or screwing tool 1 is connectible at an axial end 4 of the shaft 2 by a first torque transferring unit 6 with a motor shaft of a drive. As evident from FIGS. 6 and 7, the first torque transferring unit 6 is cut out in its radial inner portion in order to form a receiving cavity 16. This allows for the opposite inserted bit holder 7 to be configured at both ends with bits 17, 18 or similar tools in an inserted condition.

The first torque transferring unit 6 is not integrally provided in one piece in the embodiment according to FIGS. 16 and 17, but it includes a replaceable torsion element which is slidable onto the unit 6 from an outside and securable in position on the unit 6 by a retaining ring 30.

The torsion element 29 is elastic and provides direct contact to the shaft 2 when the unit 6 is inserted into the shaft 2, wherein the direct contact is provided, e.g. by a hexagonal socket. When an excessive torque is applied that could twist off the bolt head, the torsion element 29 absorbs an essential portion of the torque and thus protects the screw against damage. Additionally, the torsion element, which can be made from synthetic material, can be replaced when worn.

The second torque transferring unit 7 is insertable into the shaft 2 in two different reversed positions. Each of the bits 17, 18 or other inserted tools can then reach into the receiving cavity 16 of the first torque transferring unit 6.

A drilling and/or screwing tool 1, including an axially extending shaft 2 and an axially inner receiving channel 3, including a respective rotation secured insertion device for a torque transferring unit 6, 7 at two axially opposite ends 4, 5, thus also in particular a drilling and/or screwing tool of the type described supra, facilitates applying a head piece 19 to at least one of the torque transferring units 6, 7, wherein the head piece 19 is provided with a magnetic force oriented axially outward from the drilling and/or screwing tool 1 and configured to support a bolt or a different operating device by the magnetic force.

This head piece 19 can be retained mechanically and/or partially magnetically, in particular, at a second torque transferring unit 7, wherein the head piece 19 is applicable to a radial outside of the second torque transferring unit 7 and axially securable thereon.

Like the shaft itself, the head piece 19 is provided with retaining devices 21, thus, balls to retain the unit 7, wherein the balls are axially displaceable by a few millimeters in axial slots 22. The balls are axially pre-loaded on an out side by a spring jacket in a radially inward direction in order to provide the disengage-able axial support. An annular groove 25 is provided as a counter piece on the torque transferring unit 7.

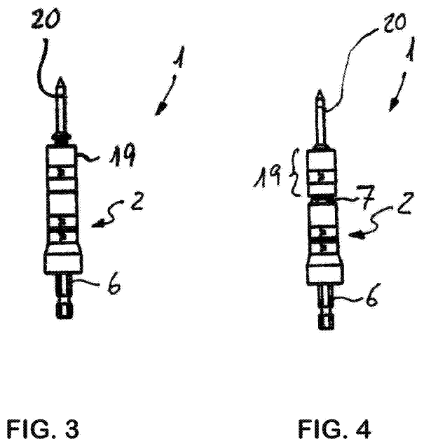

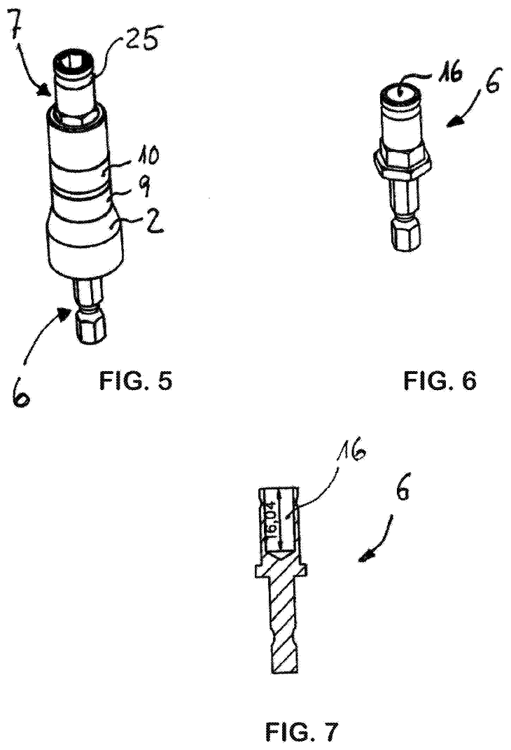

The head piece 19 is applicable to the torque transferring unit 7 in two positions that are flipped relative to one another by 180 degrees. These positions are shown in FIGS. 3 and 4. Two magnets 23, 24 are inserted into the torque transferring unit 7 in these different positions where the magnets 23, 24 mutually attract each other, so that they can retain themselves and the respective inserted bits 16, 17. In order to cause attraction between the magnets 23, 24, the magnets 23, 24 are oriented identically, so that a north pole of one magnet contacts a south pole of another magnet. An outside effect differs as a function of an insertion direction of the torque transferring unit 7 into the shaft 2. FIG. 1 shows the magnetic north pole of the magnet 23 on top. When the torque transferring unit 7 is rotated by 180 degrees, this is reversed. Since the head piece 19 is magnetic itself, it can be supported in two different positions with maximum attraction (FIG. 3) or with maximum repulsion (FIG. 4). The head piece 19 is retained in both cases by balls 21 that engage an undercut 25 of the bit holder 7 mechanically, so that a maximum possible displacement travel is defined by a length of the slots 22. Thus, the head piece 19 is axially displaceable by several millimeters relative to the supporting torque transferring unit 7 in an assembled position always oriented the same relative to the bolt 20 depending on the orientation of the unit 7.

The head piece 19 can support a ring magnet in an annular gap 26 at an outward oriented top end. The ring magnet may be a Neodym-Magnet. The magnet is provided, in particular, in an annular groove at the axial front end of the head piece 19.

The head piece 19 is pulled towards the shaft 2 by a maximum amount in the first position according to FIG. 3, so that the person operating the tool 1 has a good view of the bolt head when operating manually and also when operating motor driven.

The head piece 19 is repulsed from the axial end of the shaft 2 of the drilling and/or screwing tool 1 in the second position by a small distance of a few millimeters of axial displacement, so that the head piece 19 forms an end that protrudes axially by the largest amount and contacts a received bolt 20 or similar operating device before an inserted bit 17, 18 contacts the inserted bolt or operating device.

The head piece 19 is not mounted torque-proof at the torque transferring unit 7, but rotatable about the torque transferring unit 7 by retaining devices configured as balls 21 that are able to revolve in the undercut recess 25 of the unit 7, so that the head piece 19 is secured against axial extraction. The head piece 19 can thus initially rotate with the unit 7 and the bit 17, 18 when threading a screw 20 into a solid material, but the rotating movement of the head piece stops when the bolt head contacts the solid material, so that the head piece 19 contacts the material. This advantageously provides safety against damaging a surface of the solid material.

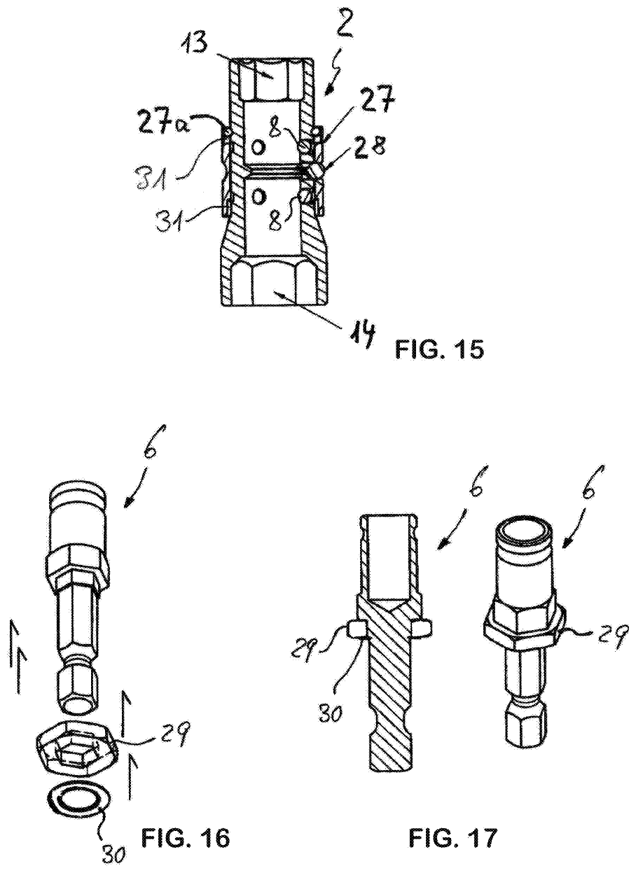

An advantageous embodiment according to FIG. 15 includes an external pressure element 27 that loads the retaining devices 8, e.g., balls, with a radially inward oriented force.

The pressure element is formed by an axially moveable sliding sleeve which is secured against axial extraction by at least one snap-locking ring 27a. The sliding sleeve 27 is configured to impart a strong radial force upon the retaining devices 8.

The sliding sleeve 27 includes relief cuts 31 on an inside. Thus, a slight axial displacement of the sliding sleeve 27 suffices to bring the retaining devices 8 into a position in the inner relief cuts 31 of the sliding sleeve 27. Thus, the retaining devices 8 are released far enough, so that a torque transferring device 6, 7 that is otherwise retained can be pulled out easily.

Otherwise, the pressure element 27 is supportable in its axial position by a spring-loaded safety 28, where the pressure element 27 presses the retaining devices 8, e.g. by spring clips 9, 10 arranged thereunder, indirectly or directly in a radially inward direction. This includes a spring that is preloaded in a radially outward direction and therefore has to be disengaged manually, e.g. by a fingertip, so that an unintentional disengagement of the pressure element is precluded.

### REFERENCE NUMERALS AND DESIGNATIONS

1 drilling and/or screwing tool
2 shaft
3 receiving channel
4 axial end
5 axial end
6 force transferring unit
7 force transferring unit
8 retaining device
9 spring jacket
10 spring jacket
11 groove
12 groove
hexagonal socket
14 hexagonal socket
15 stop
16 receiving cavity
17 bit
18 bit
19 head piece
bolt
retaining device of headpiece
22 slot
23 magnet
24 magnet
25 undercut
26 annular gap
27 pressure element
27 a snap-locking ring
28 spring loaded safety
29 replaceable torsion element
30 safety ring
31 relief cut

What is claimed is:

1. A drilling and/or screwing tool, comprising:
an axially extending shaft, including an inner axial receiving channel, including a respective rotation secured insertion device configured to receive a torque transferring unit at two axially opposite ends of the inner axial receiving channel,
wherein the respective rotation secured insertion device includes retaining devices protruding radially inward and pressable radially inward from a radial outside by a spring force and/or by an outer pressure element imparting a radially inward oriented force upon the retaining devices, so that the torque transferring unit is secured in an axial position.

2. The drilling and/or screwing tool according to claim 1, wherein the retaining devices are configured as balls.

3. The drilling and/or screwing tool according to claim 2, further comprising: pre-loaded spring jackets arranged at an outside of the shaft in axial sequence and configured to generate the spring force and to radially impress the balls.

4. The drilling and/or screwing tool according to claim 3, wherein the spring jackets are axially secured at an outside of the shaft by circumferential grooves, wherein an axial length of the circumferential grooves respectively corresponds to an axial extension of one of the pre-loaded spring jackets.

5. The drilling and/or screwing tool according to claim 1, wherein the outer pressure element is formed by an axially displaceable sliding sleeve, secured against axial extraction by a snap locking ring.

6. The drilling and/or screwing tool according to claim 5,
wherein the outer pressure element is retainable in an axial position by a spring-loaded safety, and
wherein the outer pressure element presses the retaining devices (8) radially inward indirectly or directly in the axial position.

7. The drilling and/or screwing tool according to claim 1, wherein at least three retaining devices are arranged circumferentially distributed about the shaft and configured to support the torque transferring unit.

8. The drilling and/or screwing tool according to claim 1, wherein the rotation secured insertion device respectively includes a hexagonal socket or another torque transfer profile configured as a star shape or a twelve-point socket in an axially outer edge portion of the rotation secured insertion device.

9. The drilling and/or screwing tool according to claim 8, wherein the hexagonal socket has an inner dimension of 10 mm, and a second inner socket has an inner dimension of 13 mm.

10. The drilling and/or screwing tool according to claim 1, wherein the shaft includes a stop arranged in an axial center portion of the receiving channel and effective from both axial sides and configured to contact the torque transferring unit.

11. The drilling and/or screwing tool according to claim 1, wherein the drilling and/or screwing tool is connectable at one axial end of the shaft by a first torque transferring unit with a motor shaft of a drive, and
wherein the first torque transferring unit is recessed in a radially inner portion to form a receiving cavity.

12. The drilling and/or screwing tool according to claim 11,
wherein the shaft is connectable at another end by a second torque transferring unit with a drill, a bit, or another tool insert,
wherein the second torque transferring unit is configurable with the tool insert at both its axial ends, so that the second torque transferring unit is insertable into the shaft in two different flip positions when configured with the tool insert,
wherein the tool insert is configured to penetrate the receiving cavity of the first torque transferring unit.

13. The drilling and/or screwing tool according to claim 11, wherein the first torque transferring unit includes an elastically deformable torsion element configured to transfer torque into the shaft when inserted into the shaft.

14. The drilling and/or screwing tool according to claim 13, wherein the torsion element is slidable onto the first torque transferring unit and replaceable.

15. A drilling and/or screwing tool, comprising:
an axially extending shaft, including an inner axial receiving channel, including a respective rotation secured insertion device configured to receive a torque transferring unit at two axially opposite ends of the inner axial receiving channel,
wherein a head piece is placeable onto the torque transferring unit,
wherein the head piece is provided with a magnetic force oriented axially outward from the drilling and/or screwing tool, and
wherein a bolt or another operating device is retainable in the head piece by the magnetic force.

16. The drilling and/or screwing tool according to claim 15,
wherein the head piece is placeable onto the torque transferring unit in two axial positions of the torque transferring unit that are reversed relative to each other by 180 degrees, and
wherein the head piece is repulsed by the drilling and/or screwing tool by a predetermined axial distance in the second position so that the head piece forms an end of the drilling and/or screwing tool that protrudes forward by a maximum amount, so that the head piece contacts the bolt or the other operating device before an inserted bit when the bolt or the other operating device is received in the head piece.

17. The drilling and/or screwing tool according to claims 15, wherein the head piece mounted on the torque transferring unit is axially displaceable by several millimeters relative to the torque transferring unit.
